(19) United States
(12) Patent Application Publication
(10) Pub. No.: US 2007/0069048 A1
(43) Pub. Date: Mar. 29, 2007

(54) Toothflush, a water jet oral cleaning device

(76) Inventors: Longyuan Mei, Lynn, MA (US); Zhenye Mei, Lynn, MA (US); Yan Peng, Chongqing (CN)

Correspondence Address: Zhenye Mei, 180 Broadway, Lynn, MA, 01904, US

(21) Appl. No.: 11/236,287

(22) Filed: Sep. 27, 2005

(51) Int. Cl. B05B 9/01; B05B 9/08; B05B 7/02

(52) U.S. Cl. 239/525; 239/530

(57) ABSTRACT

This is to announce the invention of a new oral irrigation device, dubbed the “Toothflush”, which is made up of a faucet adapter, hose, handle, and flushing head. The hose connects to the water source (e.g. a faucet) via the adapter on one end, and connects to the handle on the other end. The handle in turn connects to the flushing head. There are two or more slits or holes in variable sizes and shapes on the flush head arranged in any pattern. During operation, the water flows through the faucet adapter, hose, handle, and then out through the holes in the flushing head, to fulfill its objective of cleansing the teeth, tongue and oral cavity. The device's strengths lie in its simplicity, convenience of use, and effectiveness in carrying out its objective.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### FIELD OF INVENTION

The present invention relates to improvements in oral irrigation for dental hygiene.

### BACKGROUND OF THE INVENTION

Currently, there are a few devices that are marketed for maintaining dental hygiene that work with the principle of water jets such as the Waterpik™. These tooth-flushing products either have only a single water jet, which results in difficulty in “aiming” at the target, or a limited amount of water is pumped from a specific container; they have limited usage.

Mathur, U.S. Pat. No. 4,941,459, Sauer, U.S. Pat. No. 6,245,032, and Kaplowitz, U.S. Pat. No. 6,740,053 all suffer from the problem outlined above. The innovation of our device lies in its simplicity and efficacy.

There exists a patent in P.R.China, numbered 200320114787.1, under inventor Longyuan Mei, for a component similar to one of the components of the subject of this patent application.

### SUMMARY

This is a new device for maintaining teeth and oral hygiene through the use of water jets. The new device improves on the weaknesses of the current oral irrigators, with the following strategies: multiple water jets and unlimited water supply.

The device is mainly made of a hose and a flushing head. The hose connects on one end to a water source, and the other end to the flushing head.

### DRAWINGS

FIG. 1 shows the different components of the device.

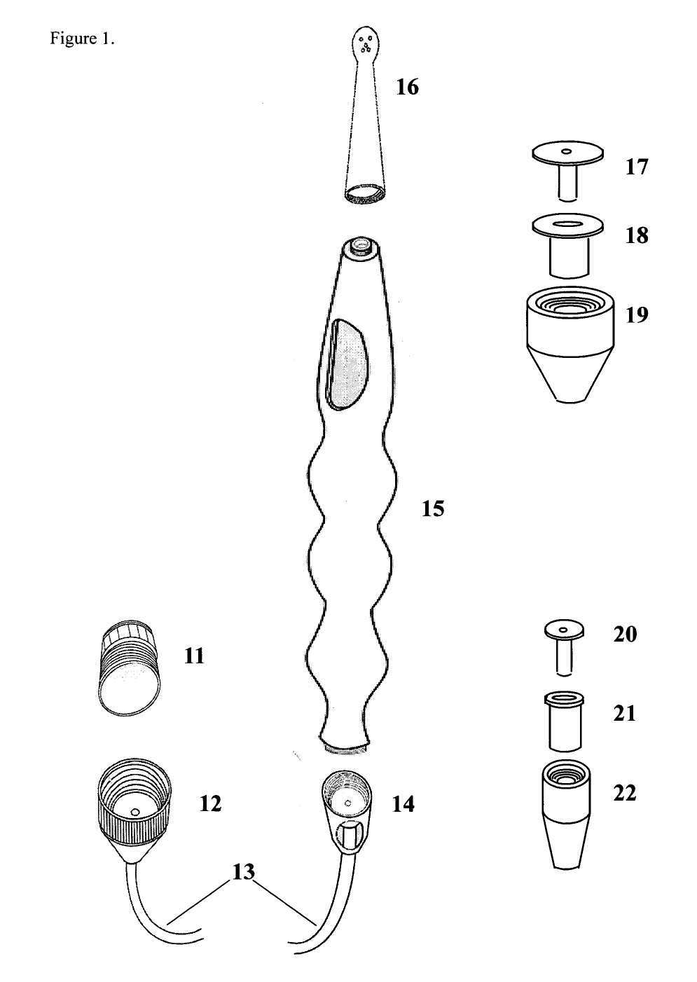

The oral cavity cleaning device, dubbed “toothflush”, is shown in FIG. 1 to be made of faucet adapter (11), hose system (12-14), flushing head handle (15), and flushing head (16).

The hose system comprises of a flexible hose (13) that connects to the faucet adapter (11) via a threading mechanism in the Faucet Hose Connector (12). The Faucet Hose Connector (12) is made up of an internal caliper (17), through which water flows while in operation, that is placed within a middle clamp (18), which is in turn placed in an external shell with inside threads (19). Similarly, the other end of the hose connects to the flushing head handle (15) via a threading mechanism in the Head Hose Connector (14). The Head Hose Connector (14) is made up of an internal caliper (20), through which water flows while in operation, that is placed within a middle clamp (21), which is in turn placed in an external shell with inside threads (22). Rubber washer rings could be used to seal the connections between some of those components (not shown).

The flushing head handle (15) can be connected to the flushing head (16) through a threading mechanism or a snapping mechanism—the flushing head (16) can be made to be screwed onto the flushing head handle (15), or it can be made to be snapped onto the flushing head handle (15). There are two or more slits or holes in variable sizes and shapes on the flush head (16) arranged in any pattern for the water to exit during operation.

Reference Numerals

11 Faucet Adapter

12 Adapter hose connector

13 Hose

14 Flushing head handle hose connector

15 Flushing head handle

16 Flushing head

17 Flushing head handle hose connector internal caliper

18 Flushing head handle hose connector middle clamp

19 Flushing head handle hose connector external shell

20 Adapter hose connector internal caliper

21 Adapter hose connector middle clamp

22 Adapter hose connector external shell

### DETAILED DESCRIPTION

Both ends of the hose are loaded with connectors, with which to connect the water source and flushing head with the hose. The two hose connectors are composed of internal calipers, middle clamps and an external shell. The flushing head has a handle that is detachable from the flushing head or fused together with the flushing head, and one of the hose connectors connects with the flushing head via the flushing head handle. There are two or more slits or holes in variable sizes and shapes on the flush head arranged in any pattern. During operation, the water would flow from the water source through the hose, flushing head handle, flushing head, and finally come out through the slits/holes in the flushing head, to complete its cleaning objective as pressured jets.

The flushing head handle can be connected to the flushing head through a threading mechanism or a snapping mechanism—the flushing head can be made to be screwed onto the flushing head handle, or it can be made to be snapped onto the flushing head handle.

The device may be made from, but not limited to, plastic, metal, ceramic, wood, rubber, or other synthetic material. There may be a sealing ring around every place of seal.

The device's strengths lie in its simplicity, convenience of use, and tested effectiveness in removing foreign substances from teeth, gum, tongue and the oral cavity.

Operation

After connecting all the components as shown in FIG. 1 together along with the water source, the user needs to simply turn on the water source, and “Toothflush” is ready to be applied to the oral cavity for cleaning purposes.

While my above description contains many specificities, these should not be construed as limitations on the scope of the invention, but rather as an exemplification of one preferred embodiment thereof. Many other variations are possible. For example, the components 11-22, as well as rubber washer rings, could be made of any appropriate predetermined material, any color, or any materially feasible size or shape.

1. A device for cleaning of teeth and oral cavity, comprised of a hose and a flushing head, where said hose is designed to be connected to a water source (e.g. a faucet) on one end and said flushing head on the other end, and
a. The device of claim 1, wherein both ends of said hose are loaded with hose connectors, with which to connect said water source and said flushing head to said hose.
b. The device of claim 1, wherein each said hose connector is composed of an internal caliper, a middle clamp and an external shell.
c. The device of claim 1, wherein said flushing head has an extended handle (a flushing head handle) which is either detachable from said flushing head or fused together as a single part with said flushing head.
d. The device of claim 1, wherein said flushing head handle has threads in one end in order for one of said hose connectors to connect said hose with said flushing head handle.
e. The device of claim 1, wherein said flushing head handle can be connected to said flushing head through a threading (screwing) mechanism or a snapping mechanism.
f. Said flushing head having a plurality of slits or holes in variable sizes and shapes, and are arranged in a plurality of patterns.
g. The device of claim 1, wherein there may be sealing rings made of rubber or other material around places of seal.
